(19) United States
(12) Patent Application Publication
(10) Pub. No.: US 2005/0067936 A1
(43) Pub. Date: Mar. 31, 2005

(54) Self-aligned gated carbon nanotube field emitter structures and associated methods of fabrication

(76) Inventors: Ji Ung Lee, Niskayuna, NY (US); William Hullinger Huber, Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/671,143

(22) Filed: Sep. 25, 2003

(51) Int. Cl. H01J 1/00; H01J 1/02; H01J 9/12; H01J 9/04

(52) U.S. Cl. 313/309; 313/495; 313/351; 445/49; 445/50; 445/51

(57) ABSTRACT

A method for fabricating a self-aligned gated carbon nanotube field emitter structure includes providing a substrate, depositing a dielectric material on the surface of the substrate and depositing a conductor layer on the surface of the dielectric material. The method also includes selectively etching the conductor layer to form an opening and selectively etching the dielectric material to form a micro-cavity. The method further includes depositing a base layer structure in the micro-cavity adjacent to the surface of the substrate, wherein the base layer structure has a substantially conical shape, and depositing a catalyst on a portion of the surface of the base layer structure, wherein the catalyst is suitable for growing at least one carbon nanotube. The method still further includes applying an electrical potential to the substrate and the conductor layer, wherein the electrical potential generates a plurality of electrical field lines that are deflected around the surface of the base layer structure, and wherein the plurality of electrical field lines have a strength that is greatest in a direction substantially perpendicular to the surface of the substrate. Finally, the method includes growing at least one carbon nanotube from the catalyst in the presence of the plurality of electrical field lines, wherein the at least one carbon nanotube is grown in a direction substantially perpendicular to the surface of the substrate.

### FIELD OF THE INVENTION

The present invention relates generally to the field of nanotechnology. More specifically, the present invention relates to self-aligned gated carbon nanotube field emitter structures and associated methods of fabrication.

### BACKGROUND OF THE INVENTION

Carbon nanotubes are currently being considered as electron emission sources in, for example, flat panel field emission display (“FED”) applications, microwave power amplifier applications, transistor applications and electron-beam lithography applications. The carbon nanotubes are typically configured in a triode field emitter structure, including a plurality of carbon nanotubes disposed within a plurality of micro-cavities that are arranged in an array, a common anode or gate electrode for modulating an emission (tunneling) current, a common dielectric layer and a common cathode electrode. The carbon nanotubes are typically disposed within the plurality of micro-cavities through an arc discharge method, a thermal chemical vapor deposition (“CVD”) method or a laser ablation method.

Triode field emitter structures have typically been fabricated using the Spindt process, which utilizes a metal, such as molybdenum (Mo), or a semiconductor material, such as silicon (Si), to form a plurality of regularly-spaced micro-tips. In the resulting Spindt field emitter array (“FEA”), electrons are emitted from the plurality of micro-tips when a relatively strong electric field is applied to the micro-tips through gates. The emitted electrons are accelerated towards the gate electrode, to which a voltage of, for example, a few to several hundred volts is applied. As a result of the relatively high gate voltage applied, residual gas particles in the surrounding vacuum collide with the emitted electrons and are ionized. The ions bombard the micro-tips, potentially damaging them. Likewise, the micro-tips are subject to pollution and deterioration, degrading the performance of the FEA and limiting its operating life. Because of these problems, the use of carbon nanotubes, which have a relatively high chemical stability, a relatively high aspect ratio and relatively high current carrying capability, is preferred as a collective electron emission source. For example, a carbon nanotube may emit electrons at an electrical field of 1 V/μm or less.

Carbon nanotube FEAs have been fabricated using a modified Spindt-like process. For example, U.S. patent application Ser. No. 09/754,148 (U.S. Patent Application Publication No. 2001/0007783) and related U.S. Pat. No. 6,339,281 disclose a method for fabricating a triode field emitter structure including the steps of (a) forming a separation layer on a gate electrode by performing slant deposition in a structure in which a cathode electrode, a gate insulation layer and the gate electrode are sequentially formed on a cathode glass substrate, a gate opening is formed on the gate electrode and a micro-cavity corresponding to the gate opening is formed in the gate insulation layer; (b) forming a catalyst layer on the cathode electrode within the micro-cavity, the catalyst layer acting as a catalyst in growing carbon nanotubes; (c) performing slant deposition on the catalyst layer, thereby forming a non-reactive layer for preventing carbon nanotubes from growing on the catalyst layer outside the micro-cavity; (d) growing at least one carbon nanotube on the catalyst layer within the micro-cavity; and (e) removing the separation layer. The dielectric layer is formed by depositing SiO₂ or Si₃N₄ to a thickness of 5-10 μm, and the diameter of the gate opening is 5-10 μm. The catalyst layer is formed by depositing nickel (Ni) or cobalt (Co), and the non-reactive layer is formed from at least one material selected from among chromium (Cr), tungsten (W), aluminum (Al), Mo and Si. The carbon nanotubes are grown by an arc discharge method, a thermal CVD method (using a transition metal, such as Ni or iron (Fe), or a silicide, such as CoSi₂, as a catalyzer) or a laser ablation method.

Conventional carbon nanotube FEAs fabricated using a modified Spindt-like process, however, suffer from several problems. The first problem is that each micro-cavity contains a tangled mass of carbon nanotubes. This tangled mass of carbon nanotubes behaves as a block conductor, leading to significant electric field shielding. Preferably, a field emitter structure includes a plurality of sharp, point-like electron emission sources (each consisting of only one or a few carbon nanotubes), rather than a block conductor. The second problem is that the carbon nanotubes are generally, but not universally, aligned perpendicular to the associated gate. Under electrostatic forces, the off-angle carbon nanotubes may be displaced and short to the gate. Likewise, the off-angle carbon nanotubes may result in emission into the gate. Preferably, all of the carbon nanotubes are aligned substantially perpendicular to the associated gate, eliminating these shorting and emission into the gate problems.

Thus, what is needed is a method for fabricating a self-aligned gated (triode) carbon nanotube field emitter structure, including a plurality of sharp, point-like electron emission sources (each consisting of only one or a few carbon nanotubes). What is also needed is a method that provides carbon nanotubes that are aligned substantially perpendicular to the associated gate, eliminating the shorting and emission into the gate problems described above. Finally, what is needed is a method that is relatively simple, cost-effective and efficient.

### BRIEF SUMMARY OF THE INVENTION

In various embodiments, the present invention provides a method for fabricating a self-aligned gated (triode) carbon nanotube field emitter structure, including a plurality of sharp, point-like electron emission sources (each consisting of only one or a few carbon nanotubes). The method of the present invention also provides carbon nanotubes that are aligned substantially perpendicular to the associated gate, eliminating the shorting and emission into the gate problems described above. Finally, the method of the present invention is relatively simple, cost-effective and efficient, and provides an enabling nanotechnology for use in, for example, x-ray imaging applications, lighting and light emission applications, flat panel field emission display (“FED”) applications, microwave power amplifier applications, transistor applications and electron-beam lithography applications.

In one embodiment of the present invention, a method for fabricating a self-aligned gated carbon nanotube field emitter structure includes providing a substrate, wherein the substrate has a surface; depositing a dielectric material on the surface of the substrate, wherein the dielectric material has a surface; and depositing a conductor layer on the surface of the dielectric material, wherein the conductor layer has a surface. The method also includes selectively etching the conductor layer to form an opening in the conductor layer and selectively etching the dielectric material to form a micro-cavity in the dielectric material. The method further includes depositing a base layer structure in the micro-cavity adjacent to the surface of the substrate, wherein the base layer structure has a surface, and wherein the base layer structure has a substantially conical shape. The method still further includes depositing a catalyst on a portion of the surface of the base layer structure, wherein the catalyst is suitable for growing at least one carbon nanotube. The method still further includes applying an electrical potential to the substrate and the conductor layer, wherein the electrical potential generates a plurality of electrical field lines that are deflected around the surface of the base layer structure, and wherein the plurality of electrical field lines have a strength that is greatest in a direction substantially perpendicular to the surface of the substrate. Finally, the method includes growing at least one carbon nanotube from the catalyst in the presence of the plurality of electrical field lines, wherein the at least one carbon nanotube is grown in a direction substantially perpendicular to the surface of the substrate.

In another embodiment of the present invention, a method for fabricating a triode carbon nanotube field emitter structure includes providing a cathode electrode, wherein the cathode electrode has a surface; depositing a dielectric layer on the surface of the cathode electrode, wherein the dielectric layer has a surface; and depositing a gate electrode on the surface of the dielectric layer, wherein the gate electrode has a surface. The method also includes selectively etching the gate electrode to form an opening in the gate electrode and selectively etching the dielectric layer to form a micro-cavity in the dielectric layer. The method further includes depositing a conductive base layer structure in the micro-cavity adjacent to the surface of the cathode electrode, wherein the conductive base layer structure has a surface, and wherein the conductive base layer structure has a substantially conical shape. The method still further includes depositing a catalyst on a portion of the surface of the conductive base layer structure, wherein the catalyst is suitable for growing at least one carbon nanotube. The method still further includes applying an electrical potential to the cathode electrode and the gate electrode, wherein the electrical potential generates a plurality of electrical field lines that are deflected around the surface of the conductive base layer structure, and wherein the plurality of electrical field lines have a strength that is greatest in a direction substantially perpendicular to the surface of the cathode electrode. Finally, the method includes growing at least one carbon nanotube from the catalyst in the presence of the plurality of electrical field lines, wherein the at least one carbon nanotube is grown in a direction substantially perpendicular to the surface of the cathode electrode.

In a further embodiment of the present invention, a self-aligned gated carbon nanotube field emitter structure is fabricated by a process that includes providing a substrate, wherein the substrate has a surface; depositing a dielectric material on the surface of the substrate, wherein the dielectric material has a surface; and depositing a conductor layer on the surface of the dielectric material, wherein the conductor layer has a surface. The process also includes selectively etching the conductor layer to form an opening in the conductor layer and selectively etching the dielectric material to form a micro-cavity in the dielectric material. The process further includes depositing a base layer structure in the micro-cavity adjacent to the surface of the substrate, wherein the base layer structure has a surface, and wherein the base layer structure has a substantially conical shape. The process still further includes depositing a catalyst on a portion of the surface of the base layer structure, wherein the catalyst is suitable for growing at least one carbon nanotube. The process still further includes applying an electrical potential to the substrate and the conductor layer, wherein the electrical potential generates a plurality of electrical field lines that are deflected around the surface of the base layer structure, and wherein the plurality of electrical field lines have a strength that is greatest in a direction substantially perpendicular to the surface of the substrate. Finally, the process includes growing at least one carbon nanotube from the catalyst in the presence of the plurality of electrical field lines, wherein the at least one carbon nanotube is grown in a direction substantially perpendicular to the surface of the substrate.

In a still further embodiment of the present invention, a triode carbon nanotube field emitter structure includes a cathode electrode, wherein the cathode electrode has a surface; a dielectric layer disposed adjacent to a portion of the surface of the cathode electrode, wherein the dielectric layer has a surface, and wherein an interior portion of the dielectric layer defines a micro-cavity; and a gate electrode disposed adjacent to the surface of the dielectric layer, wherein the gate electrode has a surface, and wherein an interior portion of the gate electrode defines an opening substantially aligned with the micro-cavity defined by the interior portion of the dielectric layer. The structure also includes a conductive base layer structure disposed adjacent to a portion of the surface of the cathode electrode within the micro-cavity defined by the interior portion of the dielectric layer and substantially aligned with the opening defined by the interior portion of the gate electrode, wherein the conductive base layer structure has a surface, and wherein the conductive base layer structure has a substantially conical shape. The structure further includes at least one carbon nanotube disposed adjacent to a portion of the surface of the conductive base layer structure, wherein the at least one carbon nanotube is substantially perpendicularly aligned with the surface of the cathode electrode.

### BRIEF DESCRIPTION OF THE DRAWINGS

The aspects and advantages of the self-aligned gated carbon nanotube field emitter structure and associated methods of fabrication of the present invention will become apparent by describing in detail preferred embodiments thereof with reference to the attached drawings, in which:

FIG. 1 is a sectional view of a portion of a conventional triode carbon nanotube field emitter structure, illustrating a tangled mass of carbon nanotubes behaving as a block conductor;

FIG. 2 is a series of sectional views illustrating a conventional method for growing field-aligned carbon nanotubes;

FIG. 3 is a sectional view of a portion of one embodiment of the self-aligned gated (triode) carbon nanotube field emitter structure of the present invention, illustrating the first step in the fabrication method of the present invention;

FIG. 4 is another sectional view of the portion of the self-aligned gated (triode) carbon nanotube field emitter structure of FIG. 3, illustrating the second step in the fabrication method of the present invention;

FIG. 5 is a further sectional view of the portion of the self-aligned gated (triode) carbon nanotube field emitter structure of FIG. 3, illustrating the third step in the fabrication method of the present invention; and

FIG. 6 is a still further sectional view of the portion of the self-aligned gated (triode) carbon nanotube field emitter structure of FIG. 3, illustrating the fourth step in the fabrication method of the present invention.

### DETAILED DESCRIPTION OF THE INVENTION

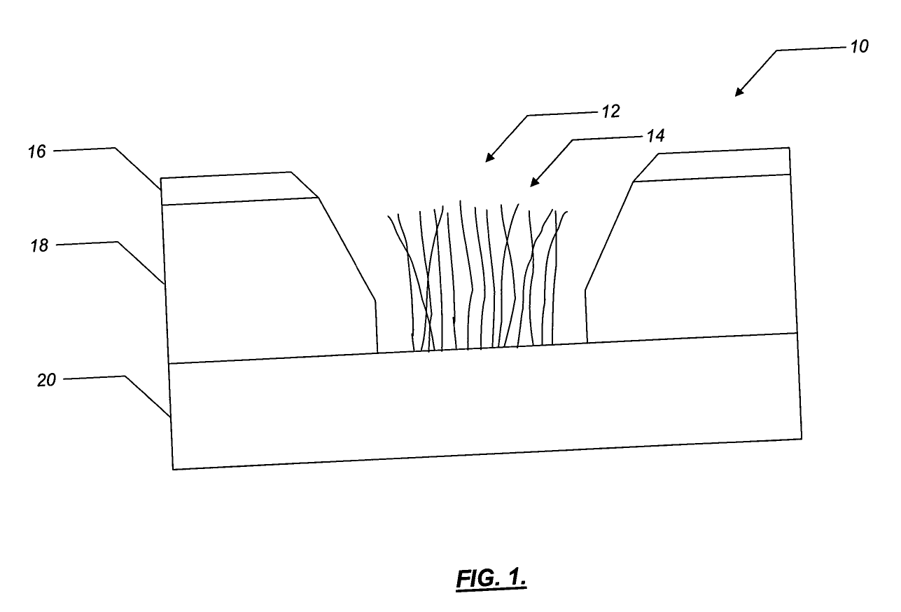

Referring to FIG. 1, as described above, a conventional carbon nanotube field emitter array (“FEA”) 10 fabricated using a modified Spindt-like process suffers from several problems. The first problem is that each micro-cavity 12 of the carbon nanotube FEA 10 contains a tangled mass of carbon nanotubes 14. This tangled mass of carbon nanotubes 14 behaves as a block conductor. Preferably, a field emitter structure includes a plurality of sharp, point-like electron emission sources (each consisting of only one or a few carbon nanotubes), rather than a block conductor. The second problem is that the carbon nanotubes are generally, but not universally, aligned perpendicular to the associated anode or gate electrode 16 (a dielectric layer 18 and a cathode electrode 20 are also illustrated). Under electrostatic forces, the off-angle carbon nanotubes may be displaced and short to the gate. Likewise, the off-angle carbon nanotubes may result in emission into the gate. Preferably, all of the carbon nanotubes are aligned substantially perpendicular to the associated gate, eliminating these shorting and emission into the gate problems.

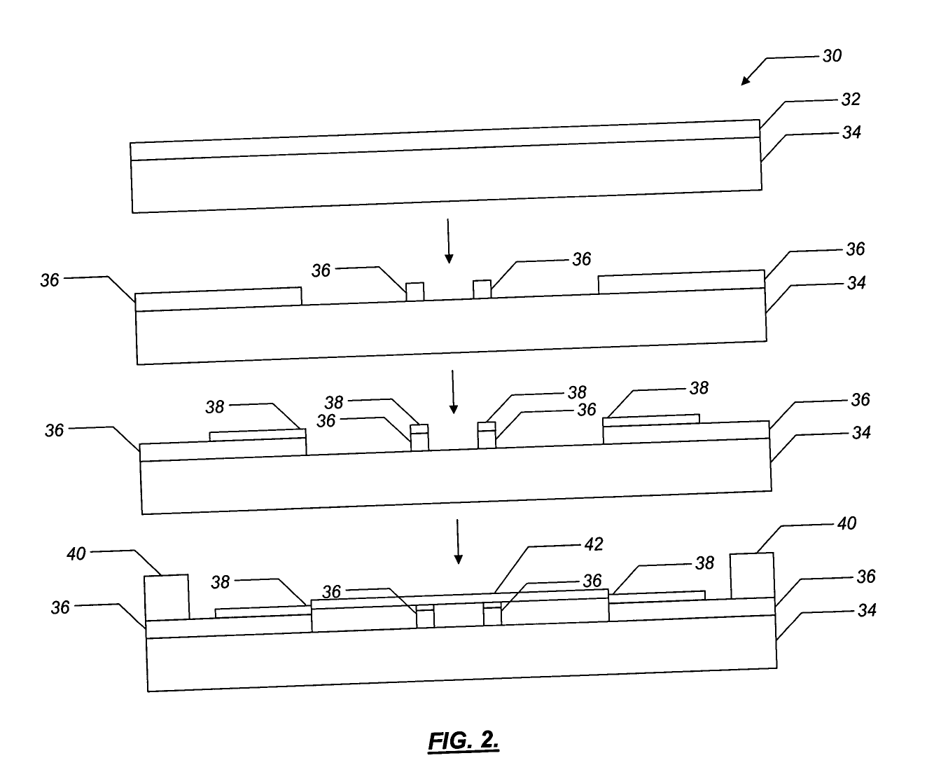

Referring to FIG. 2, a conventional method 30 for growing field-aligned carbon nanotubes (see H. Dai, Appl. Phys. Lett., Vol. 79, No. 19, Nov. 5, 2001) includes depositing a poly-Si layer 32 or the like on the surface of a substrate 34, such as quartz or the like. This poly-Si layer 32 is then etched or otherwise selectively removed to form a plurality of poly-Si sections 36. Alternatively, the plurality of poly-Si sections 36 may be selectively deposited on the surface of the substrate 34. A catalyst layer 38 suitable for growing at least one carbon nanotube is then selectively deposited on each of the poly-Si sections 36 and a plurality of electrodes 40 are selectively disposed on the poly-Si sections 36, adjacent to a portion of the catalyst layer 38. When a voltage is applied to the electrodes 40, at least one carbon nanotube 42 is grown from the catalyst layer 38. This at least one carbon nanotube 42 is substantially aligned with the field generated by the electrodes 40. This method 30 for growing a field-aligned carbon nanotube may be used in conjunction with a Spindt-like process to fabricate a self-aligned gated carbon nanotube field emitter structure.

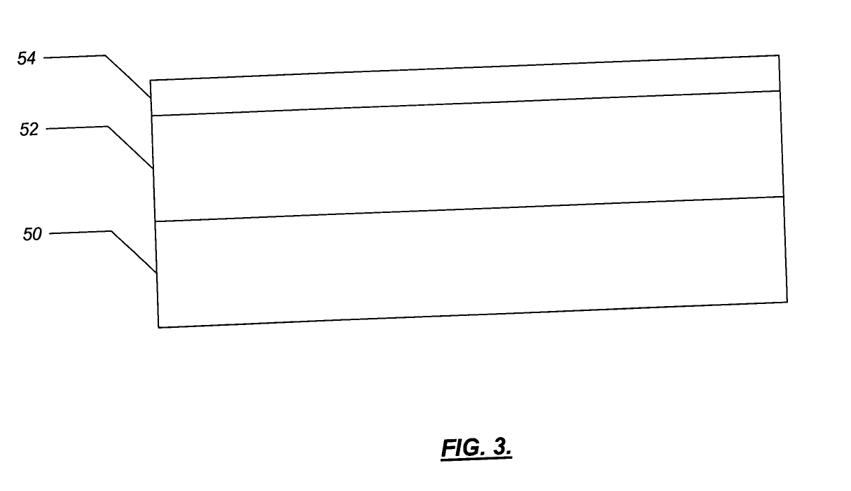

Referring to FIG. 3, in one embodiment of the present invention, a method for fabricating a self-aligned gated carbon nanotube field emitter structure includes selecting a suitable substrate 50, forming a common cathode electrode. The substrate 50 may include at least one metal, such as Mo, Pt, Al, Ti or the like, or at least one doped semiconductor material, such as Si (doped amorphous silicon, doped poly-silicon or doped crystalline silicon) or the like. The substrate 50 may also include a metal deposited on a glass, such as Mo, Pt, Al, Ti or the like deposited on a glass, or a doped semiconductor material deposited on a glass, such as Si (doped amorphous silicon, doped poly-silicon or doped crystalline silicon) or the like deposited on a glass. A dielectric material 52, such as a metal oxide, a metal nitride or a combination thereof, is then deposited or grown on the surface of the substrate 50, forming a common dielectric layer. In one embodiment, the metal oxide is one of SiO₂, Al₂O₃ and a combination thereof. In another embodiment, the metal nitride is SiNₓ, where 0.5≦x≦1.5, or the like. Non-limiting examples of such metal nitrides include SiN and Si₃N₄. The dielectric material 52 may be deposited on the surface of the substrate 50 using, for example, plasma-enhanced chemical vapor deposition (PECVD) or low-pressure chemical vapor deposition (LPCVD). The dielectric material 52 may be grown on the surface of the substrate 50 using, for example, the thermal oxidation of a silicon wafer. A conductor layer 54 is then deposited on the surface of the dielectric material 52 using, for example, sputtering, evaporation or electroplating, forming a common anode or gate electrode, referred to as the “gate layer.” The conductor layer 54 includes a metal, such as Mo, Pt, Al, Ti, a combination thereof or the like, or a doped semiconductor material, such as Si (doped amorphous silicon or doped poly-silicon) or the like.

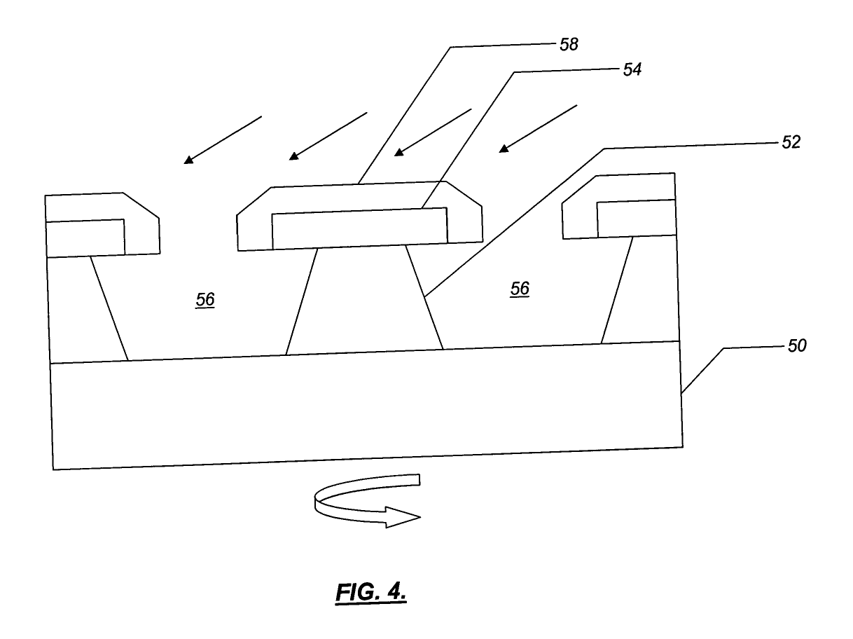

Next, a gate structure and a sacrificial layer are formed. Referring to FIG. 4, the conductor layer 54 is lithographically patterned and etched and the dielectric material 52 is wet etched, forming a plurality of micro-cavities 56 each having a substantially conical, cylindrical or other suitable shape with a diameter of between about 0.5 microns and about 3 microns. It should be noted that the shape of each of the plurality of micro-cavities 56 may vary, depending upon how the dielectric material 52 is etched. A sacrificial layer 58 is then evaporated onto the remaining portions of the conductor layer 54. The sacrificial layer 58 includes a metal, such as Al or the like, a semiconductor, or an evaporated dielectric, such as amorphous aluminum oxide, amorphous silicon oxide, amorphous silicon dioxide or the like, or it may simply consist of photoresist left on after the lithographic patterning and etching of the conductor layer 54 is completed. Preferably, the sacrificial layer 58 is evaporated onto the remaining portions of the conductor layer 54 at a predetermined angle while the substrate 50 is rotating at a predetermined rotational speed, providing uniform coverage.

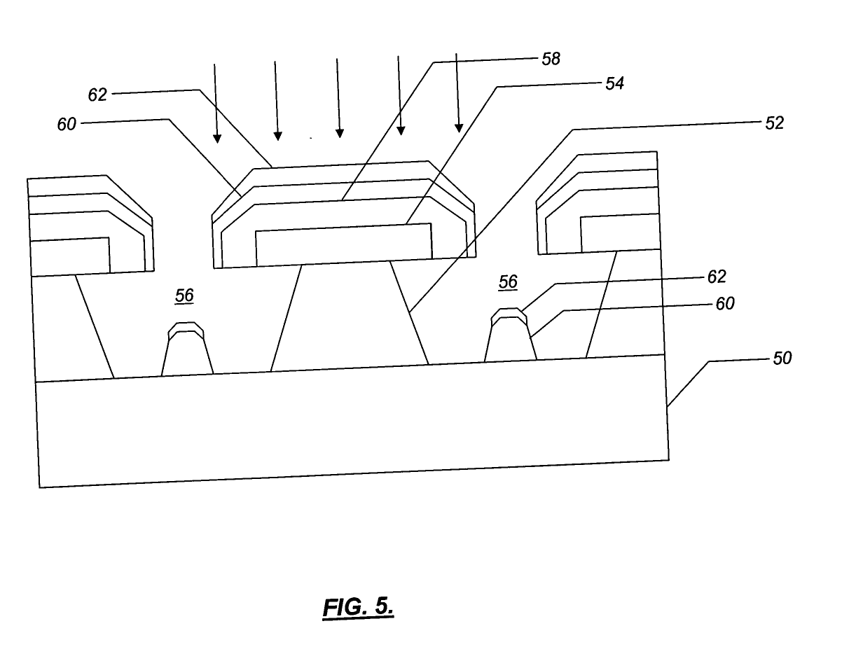

Referring to FIG. 5, a conductive base layer 60 is then evaporated onto or directionally deposited on the surface of the sacrificial layer 58. The base layer 60 may include, for example, a metal, such as Mo, Pt, Nb or the like, or a doped silicon or the like. It is important to note that a predetermined amount of the base layer 60 passes through the opening defined by the remaining portions of the conductor layer 54 at the top of each of the plurality of micro-cavities 56. This predetermined amount of the base layer 60 is deposited directly on the surface of the substrate 50, or, alternatively, is deposited directly on the surface of any sacrificial layer 58 that has been deposited in each of the plurality of micro-cavities 56. As the base layer 60 builds up on the surface of the sacrificial layer 58, the diameter of the opening defined by the remaining portions of the conductor layer 54 at the top of each of the plurality of micro-cavities 56 is gradually decreased. Thus, the predetermined amount of the base layer 60 that passes through the opening defined by the remaining portions of the conductor layer 54 at the top of each of the plurality of micro-cavities 56 is gradually decreased. Advantageously, the result is a base layer 60 that has selected portions with a substantially conical shape disposed within each of the plurality of micro-cavities 56. This shape is critical as it allows for the control of the shape of field lines used for the growth of field-aligned carbon nanotubes, as described below.

After the base layer 60 is formed, a catalyst 62 is deposited on the surface of the base layer 60, including the tip of each of the substantially conical portions of the base layer 60 disposed within each of the plurality of micro-cavities 56. Preferably, the catalyst 62 is deposited on the surface of the base layer 60 at a substantially perpendicular angle. The catalyst 62 may include, for example, a material comprising at least one transition metal. In one embodiment, the transition metal comprises at least one of Ni, Fe, Co and a suitable combination thereof. Preferably, for purposes of growing single-walled carbon nanotubes (SWCNTs), the thickness of the catalyst 62 is equal to or less than about 1 nm. It should be noted that multi-walled carbon nanotubes (MWCNTs) may also be grown instead of or in conjunction with SWCNTs. In addition, the carbon nanotubes may be metallic-type carbon nanotubes (behaving as a metal does) or semiconducting-type carbon nanotubes (behaving as a semiconductor material does), and/or semimetallic-type carbon nanotubes (behaving as a semimetal does). The carbon nanotubes have an average length of between about 50 nm and about 1,000 nm. In one embodiment, the carbon nanotubes have an average length of between about 100 nm and about 500 nm.

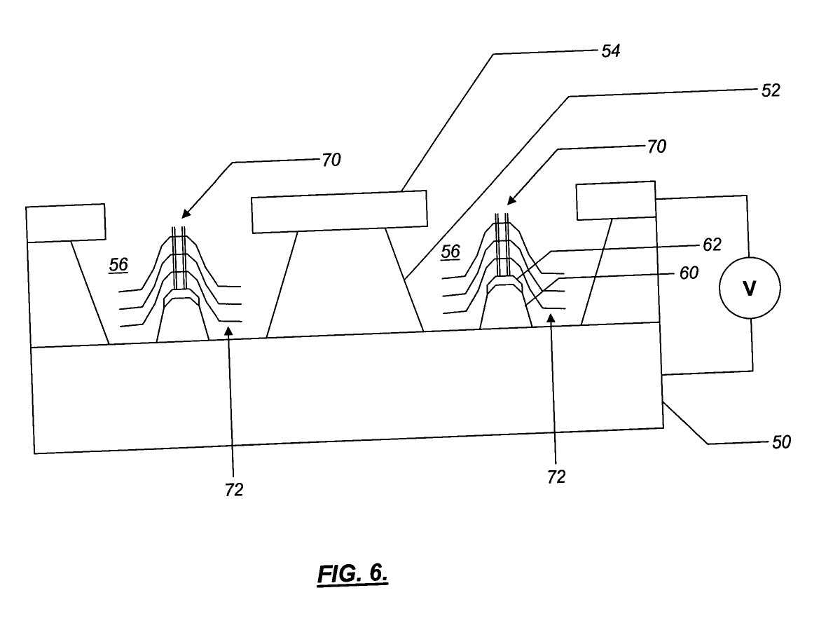

Referring to FIG. 6, the final step in the method for fabricating a self-aligned gated carbon nanotube field emitter structure includes removing the sacrificial layer 58 (FIGS. 4 and 5) using, for example, wet etching or a solvent, such as acetone or the like, applying a voltage to the common cathode electrode 50 and the common gate electrode 54 using a voltage source and growing carbon nanotubes 70 from the catalyst 62 remaining in each of the plurality of micro-cavities 56. Preferably, the voltage is between about 0.1 V and about 5 V. In one embodiment, the voltage induces an electric field of at least 10³ V/cm on the substantially conical shape. The voltage used is an important parameter and depends upon the structure of the base layer 60, the size of the associated gate openings, and the sharpness and definition of the conical structure. The voltage results in a plurality of electric field lines 72 being established in each of the plurality of micro-cavities 56. The carbon nanotubes 70 grow in the direction of the highest field lines 72 due to induced dipole moments. This direction is perpendicular to the surface of the substrate 50 because the substantially conical portions of the base layer 60 disposed within each of the plurality of micro-cavities 56 bend the field lines 72 accordingly, around the substantially conical portions of the base layer 60. Thus, the carbon nanotubes 70 grow perpendicular to the surface of the substrate 50. Advantageously, the relatively small amount of catalyst 62 used to grow the carbon nanotubes 70 results in only one to a few (about 100 or less) carbon nanotubes 70 growing in each of the plurality of micro-cavities 56, rather than a tangled mass, resulting in a plurality of sharp, point-like electron emission sources. Likewise, each of the carbon nanotubes 70 is relatively short, preventing shorting to the gate. For example, each of the carbon nanotubes 70 may be between about 0.1 microns and about 0.5 microns long. Additionally, the substantially conical portions of the base layer 60 may be selectively positioned within each of the plurality of micro-cavities 56 with respect to the gate in order to shape the potential profile within each of the plurality of micro cavities 56 and optimize carbon nanotube growth.

In general, the carbon nanotubes 70 are grown in a chemical vapor deposition (CVD) tube coupled to a flowing carbon (hydrocarbon) source, such as a methane source or an acetylene source, at between about 700 degrees C. and about 1000 degrees C. The catalyst 62 forms a plurality of “islands” at these temperatures and becomes supersaturated with carbon. Eventually, the carbon nanotubes 70 grow from these catalyst islands. This process is well known to those of ordinary skill in the art.

The self-aligned gated field emission device and triode carbon nanotube field emitter structures of the present invention are suitable for use in a variety of applications, such as x-ray imaging applications, lighting applications, flat panel field emission display applications, microwave power amplifier applications, electron-beam lithography applications and the like.

The present invention also includes electronic systems having an emissive device comprising at least one triode carbon nanotube field emitter structure as described herein. In one embodiment, the electronic system comprises an imaging system, such as, but not limited to, an x-ray imaging system or the like. In one particular embodiment, the imaging system is a computed tomography (“CT”) system. In another embodiment, the electronic system comprises a lighting system, such as, but not limited to, a fluorescent lighting system or the like. Other electronic systems that are within the scope of the present invention include x-ray sources, flat panel displays, microwave power amplifiers, lighting devices, electron-beam lithography devices and the like.

Although the present invention has been illustrated and described with reference to preferred embodiments and examples thereof, it will be readily apparent to those of ordinary skill in the art that other embodiments and examples may perform similar functions and/or achieve similar results. All such equivalent embodiments and examples are within the spirit and scope of the present invention and are intended to be covered by the following claims.

1. A method for fabricating a self-aligned gated carbon nanotube field emitter structure, comprising the steps of:
providing a substrate, wherein the substrate has a surface;
depositing a dielectric material on the surface of the substrate, wherein the dielectric material has a surface;
depositing a conductor layer on the surface of the dielectric material, wherein the conductor layer has a surface;
selectively etching the conductor layer to form an opening in the conductor layer;
selectively etching the dielectric material to form a micro-cavity in the dielectric material;
depositing a base layer structure in the micro-cavity adjacent to the surface of the substrate, wherein the base layer structure has a surface, and wherein the base layer structure has a substantially conical shape;
depositing a catalyst on a portion of the surface of the base layer structure, wherein the catalyst is suitable for growing at least one carbon nanotube;
applying an electrical potential to the substrate and the conductor layer, wherein the electrical potential generates a plurality of electrical field lines that are deflected around the surface of the base layer structure, and wherein the plurality of electrical field lines have a strength that is greatest in a direction substantially perpendicular to the surface of the substrate; and
growing at least one carbon nanotube from the catalyst in the presence of the plurality of electrical field lines, wherein the at least one carbon nanotube is grown in a direction substantially perpendicular to the surface of the substrate.

2. The method of claim 1, wherein the substrate comprises at least one of a metal, a semiconductor material, a metal deposited on a glass and a semiconductor material deposited on a glass.

3. The method of claim 1, wherein the dielectric material comprises at least one of an oxide, a nitride and a combination thereof.

4. The method of claim 3, wherein the oxide comprises at least one of SiO₂, Al₂O₃ and a combination thereof.

5. The method of claim 3, wherein the nitride comprises SiNₓ, wherein 0.5≦x≦1.5.

6. The method of claim 1, wherein the conductor layer comprises at least one of a metal and a semiconductor material.

7. The method of claim 6, wherein the metal comprises at least one of Mo, Pt, Al, Ti and a combination thereof.

8. The method of claim 6, wherein the semiconductor material comprises at least one of doped amorphous silicon and doped poly-silicon.

9. The method of claim 1, further comprising depositing a sacrificial layer on a portion of the surface of the conductor layer, wherein the sacrificial layer has a surface.

10. The method of claim 9, wherein the sacrificial layer comprises at least one of a metal, a semiconductor, an evaporated dielectric and a photoresist.

11. The method of claim 9, wherein the sacrificial layer is deposited on a portion of the surface of the conductor layer at a predetermined angle.

12. The method of claim 11, wherein the sacrificial layer is deposited on a portion of the surface of the conductor layer while the substrate is rotating at a predetermined rotational speed.

13. The method of claim 9, further comprising depositing a base layer on the surface of the sacrificial layer and a portion of the surface of the substrate, wherein the base layer has a surface, and wherein the base layer deposited on the portion of the surface of the substrate forms the base layer structure.

14. The method of claim 13, wherein the base layer comprises at least one of a metal and doped silicon.

15. The method of claim 1, wherein the base layer structure comprises at least one of a metal and doped silicon.

16. The method of claim 13, further comprising depositing the catalyst on a portion of the surface of the base layer.

17. The method of claim 16, further comprising removing the sacrificial layer, the corresponding base layer deposited on the surface of the sacrificial layer and the corresponding catalyst deposited on the surface of the base layer.

18. The method of claim 1, wherein the catalyst comprises at least one transition metal.

19. The method of claim 18, wherein the at least one transition metal comprises at least one of Ni, Fe and Co.

20. The method of claim 1, wherein the electrical potential applied to the substrate and the conductor layer is between about 0.1 V and about 5 V.

21. The method of claim 1, wherein the electric potential induces an electric field of at least 10³ V/cm on the substantially conical shape.

22. The method of claim 1, wherein the at least one carbon nanotube has a length of between about 50 nm and about 1,000 nm.

23. The method of claim 22, wherein the at least one carbon nanotube has a length of between about 100 nm and about 500 nm.

24. The method of claim 1, wherein the at least one carbon nanotube comprises at least one of a single-walled carbon nanotube, a double-walled carbon nanotube and a multi-walled carbon nanotube.

25. The method of claim 1, wherein the step of growing the at least one carbon nanotube comprises growing the at least one carbon nanotube by chemical vapor deposition.

26. The method of claim 25, wherein the step of growing the at least one carbon nanotube by chemical vapor deposition comprises growing the at least one carbon nanotube in a chemical vapor deposition tube coupled to a flowing carbon source.

27. The method of claim 26, wherein the flowing carbon source is one of a methane source, an acetylene source and a combination thereof.

28. The method of claim 25, wherein the step of growing the at least one carbon nanotube by chemical vapor deposition comprises growing the at least one carbon nanotube by chemical vapor deposition at a temperature of between about 700 degrees C. and about 1,000 degrees C.

29. The method of claim 1, wherein the at least one carbon nanotube comprises at least one of a metallic-type carbon nanotube and a semiconducting-type carbon nanotube.

30. The method of claim 1, wherein each of the depositing steps comprises a deposition technique selected from the group consisting of sputtering, thermal evaporation, electron-beam evaporation, chemical vapor deposition, plasma-enhanced chemical vapor deposition, low-pressure chemical vapor deposition and thermal oxide growth.

31. The method of claim 1, wherein the self-aligned gated carbon nanotube field emitter structure comprises a triode carbon nanotube field emitter structure.

32. A method for fabricating a triode carbon nanotube field emitter structure, comprising the steps of:
providing a cathode electrode, wherein the cathode electrode has a surface;
depositing a dielectric layer on the surface of the cathode electrode, wherein the dielectric layer has a surface;
depositing a gate electrode on the surface of the dielectric layer, wherein the gate electrode has a surface;
selectively etching the gate electrode to form an opening in the gate electrode;
selectively etching the dielectric layer to form a micro-cavity in the dielectric layer;
depositing a conductive base layer structure in the micro-cavity adjacent to the surface of the cathode electrode, wherein the conductive base layer structure has a surface, and wherein the conductive base layer structure has a substantially conical shape;
depositing a catalyst on a portion of the surface of the conductive base layer structure, wherein the catalyst is suitable for growing at least one carbon nanotube;
applying an electrical potential to the cathode electrode and the gate electrode, wherein the electrical potential generates a plurality of electrical field lines that are deflected around the surface of the conductive base layer structure, and wherein the plurality of electrical field lines have a strength that is greatest in a direction substantially perpendicular to the surface of the cathode electrode; and
growing at least one carbon nanotube from the catalyst in the presence of the plurality of electrical field lines, wherein the at least one carbon nanotube is grown in a direction substantially perpendicular to the surface of the cathode electrode.

33. The method of claim 32, wherein the cathode electrode comprises at least one of a metal, a semiconductor material, a metal deposited on a glass and a semiconductor material deposited on a glass.

34. The method of claim 32, wherein the dielectric material comprises at least one of an oxide, a nitride and a combination thereof.

35. The method of claim 34, wherein the oxide comprises at least one of SiO₂, Al₂O₃ and a combination thereof.

36. The method of claim 34, wherein the nitride comprises SiNₓ, wherein 0.5≦x≦1.5.

37. The method of claim 32, wherein the gate electrode comprises at least one of a metal and a semiconductor material.

38. The method of claim 32, further comprising depositing a sacrificial layer on a portion of the surface of the gate electrode, wherein the sacrificial layer has a surface.

39. The method of claim 38, wherein the sacrificial layer comprises at least one of a metal, a semiconductor, an evaporated dielectric and a photoresist.

40. The method of claim 38, wherein the sacrificial layer is deposited on a portion of the surface of the gate electrode at a predetermined angle.

41. The method of claim 40, wherein the sacrificial layer is deposited on a portion of the surface of the gate electrode while the cathode electrode is rotating at a predetermined rotational speed.

42. The method of claim 38, further comprising depositing a conductive base layer on the surface of the sacrificial layer and a portion of the surface of the cathode electrode, wherein the conductive base layer has a surface, and wherein the conductive base layer deposited on the portion of the surface of the cathode electrode forms the conductive base layer structure.

43. The method of claim 42, wherein the conductive base layer comprises at least one of a metal and doped silicon.

44. The method of claim 32, wherein the conductive base layer structure comprises at least one of a metal and doped silicon.

45. The method of claim 42, further comprising depositing the catalyst on a portion of the surface of the conductive base layer.

46. The method of claim 45, further comprising removing the sacrificial layer, the corresponding conductive base layer deposited on the surface of the sacrificial layer and the corresponding catalyst deposited on the surface of the conductive base layer.

47. The method of claim 32, wherein the catalyst comprises a material comprising at least one transition metal.

48. The method of claim 47, wherein the at least one transition metal comprises at least one of Ni, Fe and Co.

49. The method of claim 32, wherein the electrical potential applied to the cathode electrode and the gate electrode is between about 0.1 V and about 5 V.

50. The method of claim 32, wherein the electrical potential induces an electric field of at least 10³ V/cm on the substantially conical shape.

51. The method of claim 32, wherein the at least one carbon nanotube has a length of between about 50 nm and about 1,000 nm.

52. The method of claim 51, wherein the at least one carbon nanotube has a length of between about 100 nm and about 500 nm.

53. The method of claim 32, wherein each of the depositing steps comprises a deposition technique selected from the group consisting of sputtering, thermal evaporation, electron-beam evaporation, chemical vapor deposition, plasma-enhanced chemical vapor deposition, low-pressure chemical vapor deposition and thermal oxide growth.

54. The method of claim 32, wherein the step of growing the at least one carbon nanotube comprises growing the at least one carbon nanotube by chemical vapor deposition.

55. The method of claim 54, wherein the step of growing the at least one carbon nanotube by chemical vapor deposition comprises growing the at least one carbon nanotube in a chemical vapor deposition tube coupled to a flowing carbon source.

56. The method of claim 55, wherein the flowing carbon source is one of a methane source, an acetylene source and a combination thereof.

57. The method of claim 54, wherein the step of growing the at least one carbon nanotube by chemical vapor deposition comprises growing the at least one carbon nanotube by chemical vapor deposition at a temperature of between about 700 degrees C. and about 1,000 degrees C.

58. A self-aligned gated carbon nanotube field emitter structure fabricated by a process comprising the steps of:
providing a substrate, wherein the substrate has a surface;
depositing a dielectric material on the surface of the substrate, wherein the dielectric material has a surface;
depositing a conductor layer on the surface of the dielectric material, wherein the conductor layer has a surface;
selectively etching the conductor layer to form an opening in the conductor layer;
selectively etching the dielectric material to form a micro-cavity in the dielectric material;
depositing a base layer structure in the micro-cavity adjacent to the surface of the substrate, wherein the base layer structure has a surface, and wherein the base layer structure has a substantially conical shape;
depositing a catalyst on a portion of the surface of the base layer structure, wherein the catalyst is suitable for growing at least one carbon nanotube;
applying an electrical potential to the substrate and the conductor layer, wherein the electrical potential generates a plurality of electrical field lines that are deflected around the surface of the base layer structure, and wherein the plurality of electrical field lines have a strength that is greatest in a direction substantially perpendicular to the surface of the substrate; and
growing at least one carbon nanotube from the catalyst in the presence of the plurality of electrical field lines, wherein the at least one carbon nanotube is grown in a direction substantially perpendicular to the surface of the substrate.

59. The structure of claim 58, wherein the substrate comprises at least one of a metal, a semiconductor material, a metal deposited on a glass and a semiconductor material deposited on a glass.

60. The structure of claim 58, wherein the dielectric material comprises at least one of a metal oxide, a metal nitride and a combination thereof.

61. The structure of claim 60, wherein the metal oxide comprises at least one of SiO₂, Al₂O₃ and a combination thereof.

62. The structure of claim 60, wherein the metal nitride comprises SiNₓ, wherein 0.5≦x≦1.5.

63. The structure of claim 58, wherein the conductor layer comprises at least one of a metal and a semiconductor material.

64. The structure of claim 58, wherein the process further comprises depositing a sacrificial layer on a portion of the surface of the conductor layer, wherein the sacrificial layer has a surface.

65. The structure of claim 64, wherein the sacrificial layer comprises at least one of a metal, a semiconductor, an evaporated dielectric and a photoresist.

66. The structure of claim 64, wherein the sacrificial layer is deposited on a portion of the surface of the conductor layer at a predetermined angle.

67. The structure of claim 66, wherein the sacrificial layer is deposited on a portion of the surface of the conductor layer while the substrate is rotating at a predetermined rotational speed.

68. The structure of claim 64, wherein the process further comprises depositing a base layer on the surface of the sacrificial layer and a portion of the surface of the substrate, wherein the base layer has a surface, and wherein the base layer deposited on the portion of the surface of the substrate forms the base layer structure.

69. The structure of claim 68, wherein the base layer comprises at least one of a metal and doped silicon.

70. The structure of claim 58, wherein the base layer structure comprises at least one of a metal and doped silicon.

71. The structure of claim 68, wherein the process further comprises depositing the catalyst on a portion of the surface of the base layer.

72. The structure of claim 58, wherein the catalyst comprises a material comprising at least one transition metal.

73. The structure of claim 72, wherein the transition metal comprises at least one of Ni, Fe and Co.

74. The structure of claim 71, wherein the process further comprises removing the sacrificial layer, the corresponding base layer deposited on the surface of the sacrificial layer and the corresponding catalyst deposited on the surface of the base layer.

75. The structure of claim 58, wherein the electrical potential applied to the substrate and the conductor layer is between about 0.1 V and about 5 V.

76. The structure of claim 58, wherein the electrical potential induces an electric field of at least 10³ V/cm on the substantially conical shape.

77. The structure of claim 58, wherein the at least one carbon nanotube has a length of between about 50 nm and about 1,000 nm.

78. The structure of claim 77, wherein the at least one carbon nanotube has a length of between about 100 nm and about 500 nm.

79. The structure of claim 58, wherein the at least one carbon nanotube comprises at least one of a single-walled carbon nanotube and a multi-walled carbon nanotube.

80. The structure of claim 58, wherein the at least one carbon nanotube comprises at least one of a metallic-type carbon nanotube and a semiconducting-type carbon nanotube.

81. The structure of claim 58, wherein each of the depositing steps comprises a deposition technique selected from the group consisting of sputtering, thermal evaporation, electron-beam evaporation, chemical vapor deposition, plasma-enhanced chemical vapor deposition, low-pressure chemical vapor deposition and thermal oxide growth.

82. The structure of claim 58, wherein the at least one carbon nanotube is grown by chemical vapor deposition.

83. The structure of claim 58, wherein the self-aligned gated carbon nanotube field emitter structure comprises a triode carbon nanotube field emitter structure.

84. A triode carbon nanotube field emitter structure, comprising:
a cathode electrode, wherein the cathode electrode has a surface;
a dielectric layer disposed adjacent to a portion of the surface of the cathode electrode, wherein the dielectric layer has a surface, and wherein an interior portion of the dielectric layer defines a micro-cavity;
a gate electrode disposed adjacent to the surface of the dielectric layer, wherein the gate electrode has a surface, and wherein an interior portion of the gate electrode defines an opening substantially aligned with the micro-cavity defined by the interior portion of the dielectric layer;
a conductive base layer structure disposed adjacent to a portion of the surface of the cathode electrode within the micro-cavity defined by the interior portion of the dielectric layer and substantially aligned with the opening defined by the interior portion of the gate electrode, wherein the conductive base layer structure has a surface, and wherein the conductive base layer structure has a substantially conical shape; and
at least one carbon nanotube disposed adjacent to a portion of the surface of the conductive base layer structure, wherein the at least one carbon nanotube is substantially perpendicularly aligned with the surface of the cathode electrode.

85. The structure of claim 84, wherein the cathode electrode comprises at least one of a metal, a semiconductor material, a metal deposited on a glass and a semiconductor material deposited on a glass.

86. The structure of claim 84, wherein the dielectric layer comprises at least one of a metal oxide, a metal nitride and a combination thereof.

87. The structure of claim 86, wherein the metal oxide comprises at least one of SiO₂, Al₂O₃ and a combination thereof.

88. The structure of claim 86, wherein the metal nitride comprises SiNₓ, wherein 0.5≦x≦1.5.

89. The structure of claim 84, wherein the gate electrode comprises at least one of a metal and a semiconductor material.

90. The structure of claim 84, wherein the conductive base layer structure comprises at least one of a metal and doped silicon.

91. The structure of claim 84, wherein the at least one carbon nanotube has a length of between about 50 nm and about 1,000 nm.

92. The structure of claim 91, wherein the at least one carbon nanotube has a length of between about 100 nm and about 500 nm.

93. The structure of claim 84, wherein the triode carbon nanotube field emitter structure is suitable for use in an application selected from the group consisting of an x-ray imaging application, a flat panel field emission display application, a microwave power amplifier application, a lighting application and an electron-beam lithography application.

94. An electronic system, the electronic system having an emissive device, the emissive device comprising at least one triode carbon nanotube field emission device, wherein the at least one triode carbon nanotube field emission device comprises:
a cathode electrode, wherein the cathode electrode has a surface;
a dielectric layer disposed adjacent to a portion of the surface of the cathode electrode, wherein the dielectric layer has a surface, and wherein an interior portion of the dielectric layer defines a micro-cavity;
a gate electrode disposed adjacent to the surface of the dielectric layer, wherein the gate electrode has a surface, and wherein an interior portion of the gate electrode defines an opening substantially aligned with the micro-cavity defined by the interior portion of the dielectric layer;
a conductive base layer structure disposed adjacent to a portion of the surface of the cathode electrode within the micro-cavity defined by the interior portion of the dielectric layer and substantially aligned with the opening defined by the interior portion of the gate electrode, wherein the conductive base layer structure has a surface, and wherein the conductive base layer structure has a substantially conical shape; and
at least one carbon nanotube disposed adjacent to a portion of the surface of the conductive base layer structure, wherein the at least one carbon nanotube is substantially perpendicularly aligned with the surface of the cathode electrode.

95. The electronic system of claim 94, wherein the electronic system comprises an imaging system.

96. The electronic system of claim 95, wherein the imaging system comprises an x-ray imaging system.

97. The electronic system of claim 94, wherein the electronic system comprises a fluorescent lighting system.

98. The electronic system of claim 94, wherein the electronic system comprises at least one of an x-ray source, a lighting device, a flat panel display, a microwave power amplifier and an electron-beam lithography device.
